(19) United States
(12) Patent Application Publication
(10) Pub. No.: US 2008/0116074 A1
(43) Pub. Date: May 22, 2008

(54) ULTRASONIC DEVICE FOR TREATING A CONTINUOUS FLOW OF FLUID

(76) Inventor: Eilaz Babaev, Minnetonka, MN (US)

Correspondence Address: Bacoustics, LLC, 5929 BAKER ROAD, SUITE 470, MINNETONKA, MN, 55345, US

(21) Appl. No.: 11/562,343

(22) Filed: Nov. 21, 2006

(51) Int. Cl. B01J 19/10

(52) U.S. Cl. 204/660

(57) ABSTRACT

The present invention relates to an ultrasonic fluid treatment device comprising a tank, an inlet pipe or plurality of inlet pipes opening into said tank, an outlet pipe or plurality of outlet pipes, and an ultrasound transducer or plurality transducers within a sidewall of said tank. The transducer within a sidewall of the tank emits ultrasonic waves into the fluid that are not parallel to the primary flow of fluid through the tank. Ultrasonic waves emitted into the tank may treat the fluid, matter within the fluid, and/or organisms within the fluid in a variety of manners such as, but not limited to, cleaning objects within the fluid, sterilizing the fluid and/or objects within it, separating bonded matter within the fluid, segregating matter within the fluid into discrete laminas, killing organisms within the fluid, inactivating organisms within the fluid, extracting matter from organisms within the fluid, extracting matter from other matter within the fluid, inducing chemical reactions within the fluid, and/or converting toxic matter within the fluid into a less toxic state.

### BACKGROUND OF THE INVENTION

The present invention relates to a fluid treatment device that may be used to degrade matter within fluids, remove matter from fluids, separate matter within a fluid by density, sterilize fluids, and/or degrade toxic chemicals within a fluid.

The present invention may also be utilized to clean, sterilize, and/or deodorize objects.

Subjecting a fluid to ultrasonic waves enables various treatments of the fluid and objects or matter within the fluid. For instance, submerging objects within a fluid subjected to ultrasonic waves can clean the object. Placing a piece of solid matter such as, but not limited to, a salt pellet within a fluid subjected to ultrasonic waves causes erosion of the solid matter. Furthermore, matter bonded together may be separated when placed within a fluid subjected to ultrasonic waves. Ultrasonic waves traveling within a fluid may also be utilized to separate matter within fluid into bands or laminas.

Emitting ultrasonic waves into a fluid induces cavitations, small bubbles, within the fluid and causes objects and/or matter within the fluid to vibrate. As the ultrasound waves pass through the fluid, cavitations are spontaneously formed within the fluid. Explosion of the cavitations creates tiny areas of high pressure within the fluid. Releasing high pressure into the fluid, the explosions of the cavitations provide the energy needed to treat the fluid and objects or matter within the fluid. In addition to creating cavitations, ultrasound waves emitted into a fluid vibrate matter and/or objects within the fluid. As matter and/or objects within the fluid vibrate, bonds holding the matter together and/or bonds holding matter to an object weaken and sheer.

Ultrasonic waves emitted into a fluid in which an object is submerged remove matter from the object, thereby cleaning the object. Devices utilizing ultrasonic waves emitted into a fluid to clean objects within the fluid are disclosed in U.S. Patent Publication 2006/0086604 AI, U.S. Patent Publication 2005/0220665 AI, and U.S. Pat. No. 6,858,181 B2.

Trapping energy within cavitations, releasing energy from the explosions of cavitations, and/or inducing vibration of matter, ultrasonic waves emitted into a fluid sheer the bonds holding matter together such as, but not limited to, adhesive bonds, mechanical bonds, ionic bonds, covalent bonds, and/or van der Waals bonds, thereby separating the matter. Ultrasonic waves passing through the fluid induce vibrations in matter within the fluid. As the matter vibrates, the bonds holding the matter together begin to stretch and sheer weakening, if not breaking, the bonds. Furthermore, matter within and/or near an exploding cavitation is exposed to tremendous changes in pressure that weakens, if not breaks, the bonds. Eventually the bonds holding the matter together become so weakened and strained that they break releasing small pieces and/or molecules of the matter into the fluid. If the matter is comprised of several different substances, the different substances comprising the matter become separated and released into the fluid. Devices utilizing ultrasonic waves emitted into a fluid to break up and/or separate matter within the fluid are described in U.S. Patent Publication 2003/0183798 AI, U.S. Patent Publication 2003/0051989 AI, and U.S. Pat. No. 6,228,273 B1.

After matter within a fluid has been separated by ultrasonic waves emitted into the fluid, the matter may segregate into laminas. Segregation of matter within the fluid into laminas is assisted by the ultrasonic waves emitted into the fluid. Striking the matter the ultrasonic waves cause the matter to move through the fluid and into a particular lamina. The particular lamina that matter segregates into is dependent upon, among other things, the density of the matter. Less dense matter such as, but not limited to, gases move towards the upper lamina within the fluid. The movement of gases towards the upper lamina is driven by the ultrasonic waves colliding with the gas molecules as well as the natural tendency of matter less dense than the fluid it is in to move out of the fluid. Denser matter such as, but not limited to, solids and dense fluids, fall out of the fluid. As with less dense matter, ultrasonic waves striking dense manner exert a force on the matter in the direction the ultrasonic waves are traveling through the fluid. However, the force exerted by the ultrasonic waves on dense matter is insufficient to overcome dense matter's natural tendency to sink within the fluid. Consequently, dense matter separated from lighter matter segregates in lower laminas within the fluid. Below the laminas comprising less dense matter and above the laminas comprising dense matter, laminas containing matter of an intermediate density may form. As with dense matter and less dense matter, ultrasonic waves striking matter of an intermediate density exert a force on the matter. Unlike with dense matter, the force exerted by ultrasonic waves emitted into the fluid on matter of an intermediate density counteracts in whole or in part the natural tendency of the intermediate dense matter to sink. The more dense the matter the less effective the ultrasonic waves are at counteracting the matter's tendency to sink. Consequently, the matter will segregate into laminas based on, among other things, the density of the matter. A device utilizing ultrasonic waves emitted into fluid to separate matter within a fluid into laminas based on density is disclose in U.S. Pat. No. 6,929,750 B2.

The breaking of bonds with ultrasonic waves emitted into a fluid can also be utilized to kill and/or inactivate organisms within the fluid such as, but not limited to, bacteria, viruses, fungi, algae, and/or yeast. Separating the molecules making up an organism's cellular membranes vibrations and cavitations create holes within an organism's cellular membranes. Chemicals may enter and/or leave the organism's cytoplasm through the holes created in the cellular membranes causing the cell to lyse and/or become poisoned. In addition to disrupting cellular membranes, ultrasonic waves emitted into a fluid may also denature or otherwise damage molecules needed by the organism to survive. For example, by inducing a protein within an organism to vibrate ultrasonic waves emitted into a fluid containing the organism may cause the subunits comprising the protein to separate. Denaturing of the protein renders the protein ineffective in its life sustaining role thereby essentially removing the protein from the organism. Loss of a protein may inactivate the organism and/or eventually lead to the organism's death, if the protein is needed for survival. Devices utilizing ultrasonic waves emitted into a fluid to inactivate and/or kill organisms are disclosed in U.S. Patent Publication 2003/0234173 AI, U.S. Pat. No. 7,018,546 B2, and U.S. Pat. No. 6,444,176 B1.

Though there are devices utilizing ultrasonic waves emitted into a fluid to clean objects within the fluid, sterilize the fluid and/or objects within it, separate bonded matter within the fluid, segregate matter within the fluid into discrete laminas, and kill and/or inactivate organisms within the fluid, a device providing all of the these treatments on a large scale is lacking.

### SUMMARY OF THE INVENTION

The present invention relates to an ultrasonic fluid treatment device comprising a tank, an inlet pipe or plurality of inlet pipes opening into said tank, an outlet pipe or plurality of outlet pipes, and an ultrasound transducer or plurality of transducers within a sidewall of said tank. The transducer within a sidewall of the tank emits ultrasonic waves into the fluid that are transverse or not parallel to the primary flow of fluid through the tank. Ultrasonic waves emitted into the tank may treat the fluid, matter within the fluid, and/or organisms within the fluid in a variety of manners such as, but not limited to, cleaning objects within the fluid, sterilizing the fluid and/or objects within it, separating bonded matter within the fluid, segregating matter within the fluid into discrete laminas, killing organisms within the fluid, inactivating organisms within the fluid, extracting matter from organisms within the fluid, extracting matter from other matter within the fluid, inducing chemical reactions within the fluid, and/or converting toxic matter within the fluid into a less toxic state.

Inlet pipes feeding fluid into the tank should have a cross-sectional area smaller than that of the tank. When the fluid to be treated enters the tank, the velocity of the fluid decreases while the overall rate of flow (volume of fluid passing through the present invention per unit time) remains constant. The reduced velocity of the fluid within the tank increases the amount of treatment received by each volume of fluid passing through the tank by increasing the amount of time the fluid, matter within the fluid, and/or organisms within the fluid are exposed to ultrasonic waves. The increased exposure to ultrasonic waves may help to increase the efficacy of the ultrasonic treatment.

In certain situations, it maybe desirable to establish laminar flow in the fluid prior to exposing the fluid, matter within the fluid, and/or organism within the fluid to ultrasonic waves. Establishing laminar flow in the fluid helps to ensure the creation of stable cavitations and/or ultrasonic waves within the fluid. Utilizing laminar flow to create stable cavitations and/or ultrasonic waves within the fluid may increase the efficacy of the treatment of the fluid, matter within the fluid, and/or organisms within the fluid by ultrasonic waves emitted into in the fluid. Creating a laminar flow in the fluid as the fluid flows through the present invention entails allowing the fluid to flow a sufficient distance such that any turbulences created in the fluid from the fluid's entry into the tank, the fluid's collision with objects within the tank, and/or the fluid's collision with the walls of the tank dissipate before the fluid exits the tank. As to help establish laminar flow within the fluid prior to reaching the first transducer emitting ultrasonic waves into the fluid, the first transducer emitting ultrasonic waves into the fluid within the tank, with respect to the flow of fluid through the tank, should be located at a distance from the wall of the tank in which the inlet pipes open that is at least approximately equal to the greatest height of the opening of the inlet pipes. The length of the tank with respect to the flow of fluid through the tank should be at least approximately equal to twice the greatest height of the opening of the inlet pipes.

Determining if a particular configuration of the present invention allows for the creation a laminar flow of the fluid through the tank can be determined by observing fluid flowing through the tank. Observing fluid flow through the present invention can be accomplished by constructing a transparent mock up of the present invention. A fluid containing fine particles suspended within the fluid can then be flowed through the transparent mock up.

The transducers emitting ultrasonic waves into the fluid that are transverse or not parallel to the primary flow, overall direction of flow, of fluid through the tank may be located within any sidewall of the tank. A sidewall is any wall of the tank that is not perpendicular to the primary flow of fluid through the tank.

Any given transducer within the tank may emit ultrasonic waves of a particular frequency and/or amplitude or may emit ultrasonic waves into the tank varying in frequency and/or amplitude. The frequency of the ultrasonic waves emitted by a transducer should be at least approximately 18 kHz. Preferably a transducer emits ultrasonic waves into the tank with a frequency between approximately 20 kHz and approximately 200 kHz or between approximately 1 MHz and approximately 5 MHz. The amplitude of the ultrasonic waves emitted into the fluid by a transducer should be at least approximately 1 micron or greater. Every volume of fluid passing through the tank should be exposed to ultrasonic waves of each frequency and/or amplitude emitted into the tank for at least one second. Preferably, every gallon of fluid passing through the tank should be exposed to ultrasonic waves of each frequency and/or amplitude emitted into the tank for approximately 5 seconds.

A discrete transducer may be responsible for emitting ultrasonic waves of a particular frequency and/or amplitude or range of frequencies and/or amplitudes into the fluid flowing through the tank. Alternatively, the transducers within the sidewalls of the tank may be arranged in bands and/or array of bands responsible for emitting ultrasonic waves of a particular frequency and/or amplitude or range of frequencies and/or amplitudes into the fluid. Arranging the transducers responsible for releasing ultrasonic waves of a particular frequency and/or amplitude or range of frequencies and/or amplitudes into bands and/or arrays of bands helps to enable the creation of stable cavitations and/or ultrasonic waves of the desired frequencies and/or amplitudes within the fluid as the fluid flows through the tank.

The transducers maybe activated simultaneously. Alternatively, the transducers, bands, and/or array of bands may be activated sequentially such that a transducer, band, and/or array is activated when the preceding transducer, band, and/or array, with respect to the flow of fluid through the tank, is deactivated.

The transducers may be driven by a variety of wave patterns such as, but not limited to, square, triangle, trapezoidal, sinusoidal, and/or any combination thereof.

The intensity of the ultrasound energy released by the transducers required to treat the fluid flowing through the tank is dependent on the depth of the fluid above the transducer. The intensity required for a particular depth can be determined by placing the desired depth of fluid over a transducer. Ultrasound energy of an ever increasing intensity can then be emitted from the transducer while the surface of the fluid over the transducer is monitored. When the desired treatment of fluid is observed at the surface of the fluid, the intensity of the ultrasound energy released by the transducer should be noted and recorded, as it corresponds to the intensity required for the given depth of fluid. If the transducers located within the sidewalls of the tank are such that the ultrasonic waves emitted into the fluid intersect at an angle less than 180 degrees, then the above procedure should be performed with a depth of fluid equal to the maximum distance from the transducers to the point of intersection of the ultrasonic waves. If the ultrasonic waves emitted into the fluid from multiple transducers intersect at a 180 degree angle, then the above procedure should be performed with a depth of fluid equal to half the distance between the transducers.

Emitting ultrasonic waves of varying frequencies and/or amplitudes helps to enable treatment of fluids containing various matter and/or organisms passing through the tank. As the fluid flows through the tank, a laminar flow may be established prior to reaching the first transducer emitting ultrasonic waves into the fluid. The ultrasonic waves emitted into the fluid induce cavitations within fluid and/or vibrate any matter within the fluid. The energy released by cavitations within the fluid and the vibrations, if any, induced within any matter present in the fluid depends upon the frequency and/or amplitude of the ultrasonic waves passing through the fluid. Different matter and/or organisms within fluid may be sensitive to ultrasonic waves of different frequencies and/or amplitudes.

Exposing matter to ultrasonic waves of the proper frequency induces resonating vibrations within the matter. Resonating vibrations place the greatest amount of strain on the bonds within the matter, thereby making them more likely to break spontaneously and/or break when exposed to the energy released from the exploding cavitations. Likewise the membranes and/or molecules of different organisms will vibrate in resonance when exposed to ultrasonic waves of a particular frequency and/or amplitude thereby making the organism's membranes more likely to rupture and/or the organism's molecules more likely to denature spontaneously and/or when exposed to the energy released from the exploding cavitations.

As the cells and/or viruses within the fluid stream rupture, matter within the cells and/or viruses such as, but not limited to, proteins, nucleic acids, and/or sugars, are released into the fluid. Matter released from organisms within the fluid is then free to segregate into laminas. Segregation of material into different laminas of the fluid may be most efficient within regions of laminar fluid flow. Likewise, molecules released from the erosion of matter and/or from the breaking of bonds within the matter are free to segregate into laminas when separated. The laminas within the fluid may be collected with different outlet pipes. For example, it may be desirable to collect dense matter located within the lower laminas with an outlet pipe located near the bottom of the tank. The collected dense matter may be re-circulated through the tank as to expose the matter to further treatment. Exposing the matter to several treatments within the tank may allow more matter of a lesser density to be separated from the denser matter and/or segregate into higher laminas within the fluid. Less dense matter located within the upper laminas may be collected with an outlet pipe located near the top of the tank. Alternatively, volatile matter segregating into the upper laminas of the fluid may be allowed to escape from the fluid through the top of the tank. Matter of an intermediate density segregating into middle laminas may be collected with an outlet pipe located near the middle of the tank. The fluid and/or laminas recovered from the tank by the outlet pipes may be discharged and/or retained for further processing.

Disrupting the established laminar flow of fluid may be desirable. For instance disrupting laminar flow by creating turbulences such as, but not limited to, vortices, burbles, eddies, and/or any combination thereof may allow material segregated into discrete laminas to be remixed. Matter within laminas not disturbed by the turbulences, however, will remain segregated. Combining matter from an upper lamina and a lower lamina may be accomplished by creating a vortex within the fluid. Spiraling downward the vortices pull matter from laminas along the length of the vortices downward to lower lamina. Creating a vortex within the fluid flowing through the present invention can be accomplished by placing an outlet in the lower sidewalls of the tank. Combining matter from adjacent lamina may be accomplished by creating eddies at the boundary of two or more laminas. The turbulence created by the eddy may pull matter from upper laminas into the lower laminas and matter from the lower laminas into the upper laminas. Creating an eddy at the upper and lower boundaries of a lamina may allow material from both laminas above and below to be pulled into the lamina. Eddies can be created by placing obstructions in the tank that the fluid within the tank cannot smoothly flow around such as, but not limited to, rectangular prisms and/or triangular prisms. Alternatively, material from several adjacent laminas maybe combined by creating large burbles in the tank that span several laminas. Creating a burble can be accomplished by placing an airfoil like structure in the tank angled with respect to the flow of fluid striking the airfoil. Turbulence disrupting laminar flow may also be created by injecting fluid within the tank.

Remixing matter segregated into laminas may also be accomplished with ultrasonic waves emitted into the fluid. Emitting ultrasonic waves into the fluid that are transverse or not parallel to the force of gravity acting on the matter within the fluid may carry matter out of a lamina into which the matter has segregated and into other laminas. As ultrasonic waves not parallel to the force of gravity acting on the matter within the fluid pass through the fluid, the ultrasonic waves may direct matter within the fluid along the waves' path to anti-nodal points of the wave. If the ultrasonic waves transverse or not parallel to the force of gravity acting on the matter within the fluid span multiple laminas, then matter within one lamina may be carried to the laminas encompassing anti-nodal points of the wave.

Emitting ultrasonic waves into the fluid that are not parallel to the force of gravity acting on matter within the fluid may be accomplished with transducers located within sidewalls of the tank and/or located within walls of the tank approximately perpendicular to the primary flow of fluid through the tank.

Selectively mixing material segregated into lamina may be desirable if chemical reactions are to take place within the present invention. For instance, matter within the fluid flowing through the present invention may react to form a desired product. However, formation of the desired product may be hindered by the presence of other matter within the fluid. The other matter may be a separate reagent, a product of the reaction producing the desired product, and/or the desired product itself. The other matter may react with the reagents producing the desired product, thereby preventing the production of the desired product. Alternatively, reacting with the desired product, the other matter may convert the desired product into an undesired product. Segregating the reagents, desired product, and/or other matter into discrete lamina and then selectively recombining the lamina allows other matter that hinders and/or prevents the formation of the desired product from reacting with the reagents producing the desired product and/or from reacting with the desired product.

Similarly, segregating the reagents, desired product, and/or other matter into discrete lamina allows optimization of desired chemical reactions. Thus, after a chemical reaction occurring within and/or outside the present invention, a laminar flow of fluid may be established within the fluid flowing through the present invention. The matter within the fluid may then be allowed to segregate into discrete lamina. Selectively remixing lamina within the tank containing matter that reacts to produce the desired product and/or reaction may then be remixed within the tank by creating turbulences within the fluid and/or remixed outside of the present invention. Following and/or during the selective remixing of the laminas, the matter within the combined laminas may then be allowed to react within and/or outside the present invention. Serially segregating, recombining, and/or reacting the matter within the fluid may be done with one unit of the present invention and/or within several units of the present connected in series and/or in parallel.

Reactions occurring within the tank may be catalyzed by a variety of agents, such as, but not limited, chemicals, microorganisms, enzymes, radio waves, microwaves, light waves, and/or any combination thereof introduced, into the fluid while and/or prior to the fluid flowing through the present invention. For instance, prior to the fluid entering the tank from the inlet pipe, a chemical such as, but not limited to, chlorine, bromine, ozone, antibiotic, antifungal, antiviral, and/or any combination thereof, may be introduced into the fluid. The introduced chemical may react with fluid, with matter within the fluid, and/or with organism within the fluid as to bring about a desired result. For instance, the chemical may react with matter within the fluid as to transform the matter into a less toxic state. Alternatively, the chemical may react with organisms within the fluid as to kill and/or deactivate the organisms. The energy within and/or released from cavitations within the fluid and/or vibrations of matter and/or organisms within the fluid may increase the efficacy and/or rate of the chemical reaction.

According, one aspect of the present invention to may be to clean objects submerged in a fluid flowing through the present invention.

Another aspect of the present invention may be to sterilize objects submerged in a fluid flowing through the present invention.

Another aspect of the present invention may be to deodorize objects submerged in a fluid flowing through the present invention.

Another aspect of the present invention may be to sterilize a fluid flowing through the present invention.

Another aspect of the present invention may be to inactivate organisms within a fluid flowing through the present invention.

Another aspect of the present invention may be to kill organisms within a fluid flowing through the present invention.

Another aspect of the present invention may be to deodorize a fluid flowing through the present invention.

Another aspect of the present invention may be to separate bonded matter within a fluid flowing through the present invention.

Another aspect of the present invention may be to release matter within organisms within a fluid flowing through present invention into the fluid flowing through the present invention.

Another aspect of the present invention may be to segregate matter within a fluid flowing through the present invention into lamina.

Another aspect of the present invention may be convert toxic matter within a fluid flowing through the present invention into a less toxic state.

Another aspect of the present invention may be to remove gases from the fluid flowing through the present invention.

Another aspect of the present invention may be to extract matter from a combination of matter within a fluid flowing through the present invention.

Another aspect of the present invention may be to extract matter from cells within a fluid flowing through the present invention.

Another aspect of the present invention may be to extract matter from viruses with a fluid flowing through the present invention.

These and other aspects of the invention will become more apparent from the written description and figures below.

### BRIEF DESCRIPTIONS OF THE DRAWINGS

The present invention will be shown and described with reference to the drawings of preferred embodiments and clearly understood in detail.

FIG. 1 depicts a cross sectional view of the ultrasound fluid treatment device of the present invention.

FIG. 2 depicts a three dimensional view of the ultrasound fluid treatment device of the present invention.

FIG. 3 depicts cross sectional views of the tank and inlet pipes of the fluid treatment device of the present invention.

FIG. 4 depicts a cross sectional view of an alternative configuration of the fluid treatment device of the present invention further comprising multiple outlet pipes collecting different laminas of the fluid within the tank.

### DETAILED DESCRIPTION OF THE INVENTION

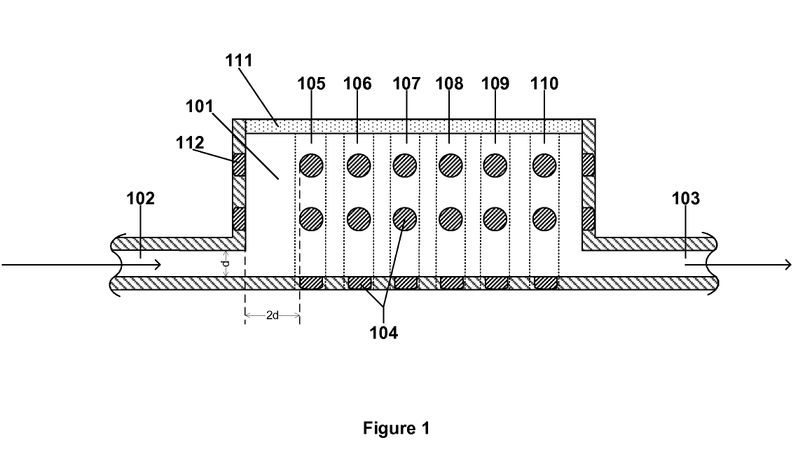

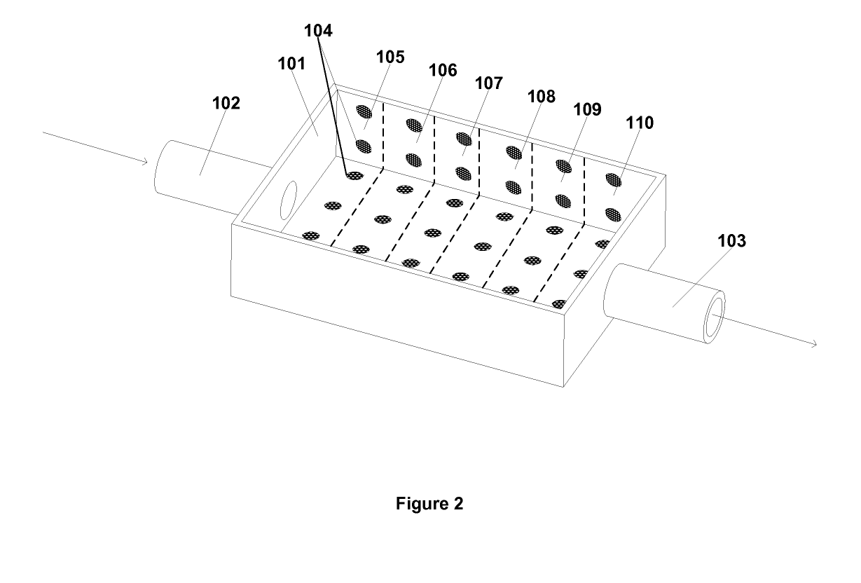

Depicted in FIG. 1 and FIG. 2 is a possible configuration of the ultrasound fluid treatment device of the present invention comprising a tank 101, an inlet pipe 102 opening into to said tank 101, an outlet pipe 103, and an ultrasound cymbal transducer 104 or plurality cymbal transducers within a sidewall of said tank. The first cymbal transducer 104 emitting ultrasonic waves into a fluid within said tank is located at a distance from said inlet pipe 102 such that laminar flow is established within the fluid prior to said first cymbal transducer. Fluid enters tank 101 through inlet pipe 102. As the fluid enters tank 101, the velocity of the fluid decreases. Laminar flow is established within the fluid before it reaches the first cymbal transducer 104 emitting ultrasonic waves into the fluid within tank 101 that are transverse or not parallel to the flow of fluid through tank 101.

As the fluid flows through tank 101, ultrasonic waves are emitted into the fluid from cymbal transducers 104. Any given cymbal transducer 104 within the sidewall of tank 101 may emit ultrasonic waves of a particular frequency and/or amplitude or may emit ultrasonic waves into the tank varying in frequency and/or amplitude. A discrete cymbal transducer 104 may be responsible for emitting ultrasonic waves of a particular frequency and/or amplitude or range of frequencies and/or amplitudes into the fluid flowing through tank 101. Alternatively, cymbal transducers 104 within a sidewall of tank 101 may be arranged in bands, as depicted in FIG. 1 by elements 105, 106, 107, 108, 109, and 110, responsible for emitting ultrasonic waves of a particular frequency and/or amplitude or range of frequencies and/or amplitudes into the fluid.

As to establish laminar flow prior to the first cymbal transducer 104 and/or band of cymbal transducers 105 emitting ultrasonic waves into the fluid within tank 101, with respect to the flow of fluid through tank 101, the first cymbal transducer 104 and/or band of cymbal transducers 105 should be located at least a distance d, preferably 2*d, from the wall of tank 101 in which inlet pipe 102 opens, where d is approximately the greatest height of the opening of the inlet pipe 102. The length of tank 101 with respect to the flow of fluid through tank 101 should be at least equal to a distance of approximately 2*d. Volatile matter segregating into the upper laminas of the fluid passing through tank 101 may be allowed to escape from the fluid by passing through porous material 111 covering tank 101. After being treated by the ultrasonic waves emitted into tank 101 by cymbal transducers 104, the fluid exits tank 101 through outlet pipe 103. Before exiting through outlet pipe 103, matter and/or organisms segregated into discrete laminas may be remixed by ultrasonic waves emitted from transducers 112 and/or transducers 104 emitting ultrasonic waves transverse or not parallel to the force of gravity acting on matter and/or organisms within tank 101.

Though cymbal transducers are depicted in FIG. 1, other types of transducers such as, but not limited to, Langevin transducers may be used.

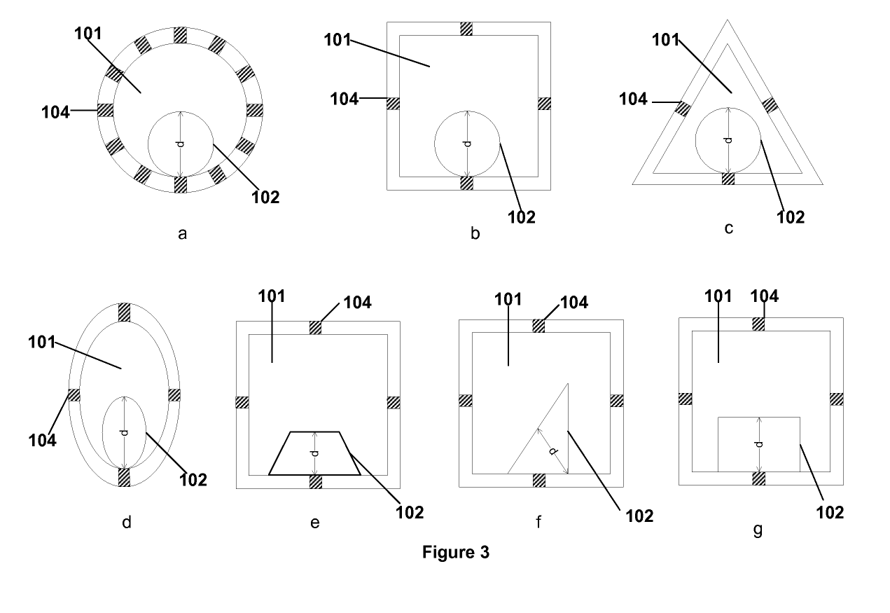

Depicted in FIG. 3 are cross sections of different possible configurations of tank 101 and inlet pipe 102. As depicted in FIG. 3a through 3c, inlet pipe 102 may have a circular opening. Alternatively, as depicted in FIG. 3d, inlet pipe 102 may have an elliptical opening. The opening of inlet pipe 102 may also have triangle, trapezoid, or rectangle configuration as depicted in FIGS. 3e, 3f, and 3g respectively. Tank 101 may be configured as a cylinder, rectangular prism, triangular prism, or elliptical prism, as depicted in FIG. 1a, 1b, 1c and 1d respectively. Tank 101 and the opening of inlet pipe 102 may have other configurations and/or combinations other than those depicted in FIG. 3, so long as the as the cross sectional area of tank 101 is larger than the cross sectional area of inlet pipe 102.

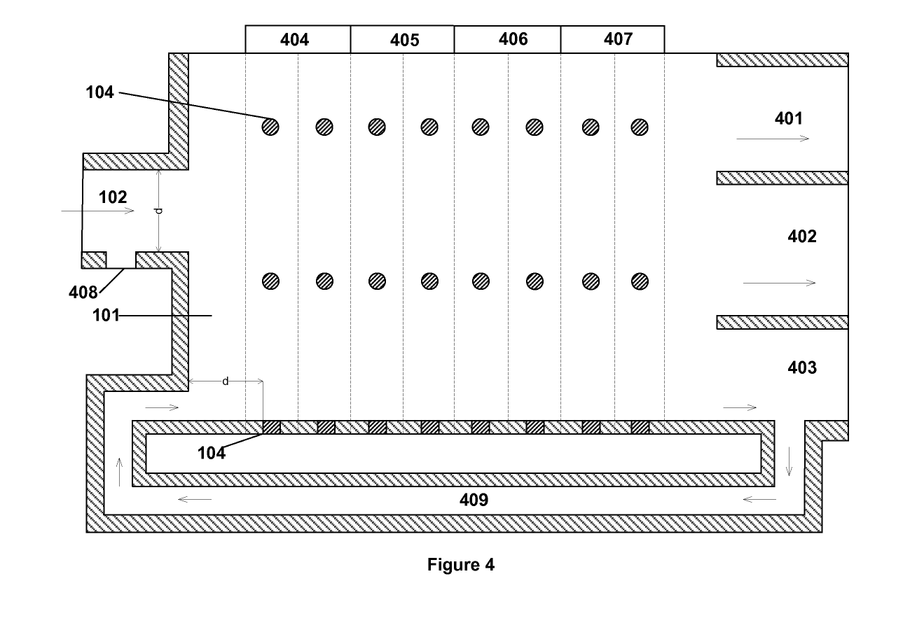

Depicted in FIG. 4 is cross sectional view of an alternative configuration of the ultrasound fluid treatment device of the present invention further comprising multiple outlet pipes 401, 402, and 403 collecting different laminas of the fluid within tank 101. As depicted, outlet pipes 401, 402, and 403 may be spaced closely together as to permit the laminas to be collected to smoothly flow into outlet pipe 401, 402, and 403. Alternatively, the outlet pipes 401,402, and/or 403 may be spaced apart from each other as to permit the creation of turbulences mixing the laminas as the laminas exit tank 101 or to control fluid depth. Outlet pipe 403 collects the lower laminas of the fluid within tank 101.

As also shown in FIG. 4, Pipe 409, connected to outlet pipe 403, re-circulates at least a portion of the lower laminas of fluid collected by outlet pipe 403 into tank 101 as to expose the matter within the lower lamina to further treatment within tank 101. As to facilitate the creation of laminar flow of fluid through tank 101, the sum of the pressure within inlet pipes 102 and recirculation pipe 409 is approximately equal to the sum of the pressure within outlet pipes 401, 402, and 403. The bands of cymbal transducers 104 within a sidewall of tank 101 are arranged in arrays 404, 405, 406, and 407 responsible for emitting ultrasonic waves of a particular frequency and/or amplitude or range of frequencies and/or amplitudes into the fluid within tank 101. Prior to the fluid entering tank 101 from inlet pipe 102, a chemical may be introduced into the fluid through orifice 408.

The top of tank 101 may be sealed with a sidewall as depicted in FIG. 4, or a porous material, as depicted in FIG. 1. Alternatively, the top of tank 101 may be open. An open top permits objects to be lowered into and/or moved through the fluid flowing through tank 101, thereby permitting the object to be cleaned, sterilized, deodorized, and/or any combination thereof.

Although specific embodiments have been illustrated and described herein, it will be appreciated by those of ordinary skill in the art that any arrangement that is calculated to achieve the same or similar purpose may be substituted for the specific embodiments. It is to be understood that the above description is intended to be illustrative and not restrictive. Combinations of the above embodiments and other embodiments will be apparent to those having skill in the art upon review of the present disclosure. The scope of the present invention should be determined with reference to the appended claims, along with the full scope of equivalents to which such claims are entitled.

The method of action of the present invention and prior art devices presented herein are based solely on theory. They are not intended to limit the method of action of the present invention or exclude possible methods of action that may be present within the present invention and/or responsible for the actions of the present invention.

1-125. (canceled)

126. A fluid treatment device comprising:
a tank having a sidewall;
an inlet pipe for supplying a fluid into the tank;
an outlet pipe for removing the fluid;
at least one ultrasound transducer within the sidewall emitting ultrasonic waves at a frequency and an amplitude to produce cavitation within the fluid in the tank; and
the ultrasound transducer also located so that the ultrasonic waves are emitted into a laminar flow region of the tank.

127. The device of claim 126 wherein the ultrasound transducer emits ultrasonic waves over a range of frequencies.

128. The device of claim 126 wherein the ultrasound transducer emits ultrasonic waves over a range of amplitudes.

129. The device of claim 127 wherein the ultrasound transducer emits ultrasonic waves over a range of amplitudes.

130. The device of claim 126 having at least one band of transducers within the sidewall of the tank.

131. The device of claim 126 having at least one array of transducers within the sidewall of the tank.

132. The device of claim 126 wherein the transducer is located a distance from the inlet pipe that is at least approximately equal to the greatest dimension of the opening of the inlet pipe.

133. The device of claim 126 wherein the transducer is located a distance from the inlet pipe that is at least equal to approximately twice the greatest dimension of the opening of the inlet pipe.

134. The device of claim 126 wherein chemicals are introduced into the fluid prior to the fluid entering the tank.

135. The device of claim 126 wherein catalysts are introduced into the fluid prior to the fluid entering the tank.

136. The device of claim 126 wherein the tank has a depth that can be varied.

137. The device of claim 126 wherein the fluid segregates into discrete laminas.

138. The device of claim 126 wherein a dense matter lamina is separated and recirculated.

139. The device of claim 126 also having a means for collecting a gas product.

140. The device of claim 126 also having a means for collecting a portion of the fluid containing at least one product.

141. The device of claim 126 having the ultrasound waves with the amplitude of 1 micron or greater.

142. The device of claim 126 having the fluid exposed to the ultrasonic waves for at least 1 second.

143. The device of claim 126 having the ultrasound waves with the frequency within the range of 20 kHz to 200 kHz.

144. The device of claim 126 having the ultrasound waves with the frequency within the range of 1 mHz to 5 mHz.

145. The device of claim 126 having the ultrasound transducer driven by a wave pattern selected from the group of consisting of; square, sinusoidal, trapezoidal or triangular.

146. The device of claim 126 having a turbulent zone to remix at least two laminas.

147. The device of claim 126 having a plurality of outlet pipes to collect selected laminas.

148. A fluid treatment device comprising:
a tank having a sidewall;
an inlet pipe for supplying a fluid into the tank;
an outlet pipe for removing the fluid;
at least one ultrasound transducer within the sidewall emitting ultrasonic waves at a frequency and an amplitude; and
the ultrasound transducer also located so that the ultrasonic waves are emitted into a laminar flow region of the tank.
